(19) United States
(12) Patent Application Publication
(10) Pub. No.: US 2010/0018919 A1
(43) Pub. Date: Jan. 28, 2010

(54) SYSTEM FOR TREATING RECIRCULATION NUTRIENT USING FLOATING MEDIA

(76) Inventors: Sang ill Lee, Cheongju-si (KR); Keum Young Kim, Cheongju-si (KR); Jin Hyung Kim, Cheongwon-gun (KR); Joa Hyoung Kang, Oakeseong-gun (KR); Hyoung soon Park, Cheongi-si (KR); Tae Su Kim, Chungju-si (KR)

Correspondence Address: HUGHES LAW FIRM, PLLC, 5160 Industrial Place,#107, Ferndale, WA, 98248-7819, US

(21) Appl. No.: 12/558,801

(22) Filed: Sep. 14, 2009

(30) Foreign Application Priority Data
Jun. 1, 2007 (KR) 10-2007-0053967

(51) Int. Cl. C02F 3/30; C02F 3/08

(52) U.S. Cl. 210/605; 210/195.1; 210/150

(57) ABSTRACT

A system for treating recirculating nutrients using floating media is disclosed. The system is operated in such way that wastewater influent path is changed between a first mode and a second mode at a certain period of time interval. Wastewater influent at the first mode sequentially flows into a first anoxic tank, a second anoxic tank, and an aerobic tank. Wastewater influent at the second mode sequentially flows into the second anoxic tank, the first anoxic tank, and the aerobic tank. Part of the wastewater that flows into the aerobic tank bypasses the first anoxic tank and the second anoxic tank. Part of the wastewater, which flows from the aerobic tank into the first anoxic tank or from the aerobic tank into the second anoxic tank, continuously bypasses the aerobic tank through an internal recirculation pump.

### RELATED APPLICATIONS

This application claims priority benefit of International Publication Number WO 2008/147019 A1, filed on Feb. 19, 2008, which claims priority benefit of Korean Application Number 10-2007-0053967, filed on Jun. 1, 2007.

### BACKGROUND OF THE DISCLOSURE

a) Field of the Disclosure

The present invention relates to a system for treating recirculating nutrients using floating media. More particularly, this invention relates to a system that is operated in such way that wastewater influent path is changed between a mode A and a mode B at a certain period of time interval. Wastewater influent at mode A sequentially flows into a first anoxic tank, a second anoxic tank, and an aerobic tank. Wastewater influent at mode B sequentially flows into the second anoxic tank, the first anoxic tank, and the aerobic tank. Part of the wastewater which flows into the aerobic tank bypasses the first anoxic tank and the second anoxic tank. Part of the wastewater, which flows from the aerobic tank into the first anoxic tank or from the aerobic tank into the second anoxic tank, continuously bypasses the aerobic tank through an internal recirculation pump.

b) Background Art

In general, the nutrients contained in wastewater are comprised of inorganic elements. When water containing nutrients flows into rivers, oceans, lakes, marshes, and reservoirs, the nutrients facilitate the growth of algae and thus cause eutrophication.

When wastewater containing nutrients flows into sea, a red tide is produced; eventually the nutrients from this red tide rot on the sea floor, emitting a strong odor and thereby facilitating water pollution. Therefore, these nutrients must be removed from wastewater before the wastewater flows into rivers, lakes, and marshes.

Most sewage water and wastewater is treated by an activated sludge process in the Republic of Korea. The activated sludge process can remove most of the suspended solids and organic matters, but treats only 20-40% of nutrients, such as nitrogen and phosphorus.

Nutrients, such as nitrogen and phosphorus, are treated through physical and chemical treatment processes and a biochemical treatment process. The physical treatment process includes ammonia stripping, ion exchange, and the formation and settling of struvite, etc. The physical treatment process is disadvantageous in that it is temperature-sensitive and cannot treat completely wastewater. Also, the physical treatment process has drawbacks because it involves high cost and expensive maintenance fees.

The conventional A/0 process of Air Products & Chemicals Inc. is performed through an anaerobic zones and an aerobic zone, which are divided into a plurality of compartments. The conventional A/0 process is the same concept as the Phoredox process proposed by Barnard in 1973. The anaerobic zone is configured to include three compartments and the aerobic zone is configured to include four compartments. These compartments are configured to be consecutive and follow the formation of a completely mixed flow reactor, thereby performing a single-sludge suspended growth treatment process. Nitrification can be achieved as the retention time is properly set at an aerobic stage. Recycled sludge is recirculated to the end portion through which inflow flows into the reactor to mix with the wastewater flowing there into. Under the anaerobic conditions, phosphorous accumulated in microorganisms transferred with wastewater is discharged as soluble phosphorous. While the soluble phosphorous is discharged, part of BOI) is removed therefrom. The eluted phosphorous is taken up by microorganisms in an aerobic zone, which is referred to as luxury P take, and removed through waste sludge. The phosphorous concentration contained in the effluent water depends on the BOD of wastewater. When the ratio of BOD and phosphorus is greater than 10:1, it is reported that the concentration of soluble salt contained in the effluent water may become equal to or less than 1 mg/L. When the ration of BOD and phosphorus is equal to or less than 10:1, metal salt may be introduced to the process to lower the concentration of phosphorous contained in the effluent water. SRT is relatively short, 2-6 days, for example, and its process efficiency is similar to the five stage Bardenpho process.

The anaerobic/anoxic/oxic (A2/0) process is configured in such a way that three identical anoxic tanks, serving as a completely mixed flow (DMF) reactor, are installed after an anaerobic tank, in order to remove nitrogen through denitrification of the A/0 process and to reduce load nitrate of recirculating sludge applied to the anaerobic tank through the denitrification. Generally, the SRT of the anoxic tank is about 1 hour.

It is known that, in the A2/0 process, the efficiency of nitrogen removal is 40-70% and the efficiency of phosphorous removal is less than that of the A/0 process. The concentration of phosphorus in the effluent water is treated less than 2 mg/L provided that the effluent water is not filtered, but less than 1.5 mg/L provided that the effluent water is filtered.

However, both the A2/0 and A/0 processes have a secondary problem in that the sludge must be treated. To resolve this, a membrane-bio reactor using floating media must be employed.

The activated sludge process is disadvantageous in that it generates sludge that must be treated. Since the continuous influent water, as upflow, inflows without accompanying air, the media is compressed after a certain period of time elapses. Also, the solidified media is not be broken and moved as blocks, and thus back washing cannot be smoothly performed. Therefore, the problem related to the backwashing process must be resolved, so that the process can be applied to the site and can function smoothly.

### SUMMARY OF THE DISCLOSURE

The present invention solves the above problems, and provides a system for treating recirculating nutrients using floating media that produces causes virtually no hardly wastewater as floating media is filled into reactors and can be installed in a relatively small site because it does not require the settling basin.

The present invention further provides a system for treating recirculating nutrients using floating media that can resolve the problems of backwashing which remain in the conventional membrane-bio filtering system using floating media.

In accordance with an exemplary embodiment of the present invention, the present invention provides a system for treating recirculating nutrients using floating media, wherein wastewater influent path is changed between a first mode (A) and a second mode (B) at a certain period of time interval.

Here, the first mode (A) where wastewater sequentially flows into a first anoxic tank and a second anoxic tank in which microorganism adsorbs organic matter contained in the wastewater, and then an aerobic tank in which the wastewater concentrating ammonia nitrogen, which has undergone the organic matter adsorption process, is nitrified by concentrated nitrifying bacteria, at a certain period of time interval. The second mode (B) where wastewater sequentially flows into the second anoxic tank and the first anoxic tank in which microorganism adsorb organic matter contained in the wastewater, and then an aerobic tank in which the wastewater concentrating ammonia nitrogen, which has undergone the organic matter adsorption process, is nitrified by concentrated nitrifying bacteria.

Part of the wastewater that flows into the aerobic tank at the first mode (A) and the second mode (B) bypasses the first anoxic tank or the second anoxic tank. Part of the wastewater that flows from the aerobic tank into the first anoxic tank or from the aerobic tank into the second anoxic tank continuously bypasses the aerobic tank through an internal recirculation pump.

Preferably, the first mode (A) allows for internal recirculation at 1˜4 Q times the amount of influent from the aerobic tank to the second anoxic tank to enhance the denitrification efficiency. Also, the second mode (B) allows for internal recirculation at 1˜4 Q times the amount of influent from the aerobic tank to the first anoxic tank to enhance the denitrification efficiency.

Preferably, the first and second anoxic tanks and the aerobic tank are filled with the floating media.

Preferably, the floating media is made of KPP whose cell structure is a closed form and is flexible due to PP resin. Also the floating media is shaped as a sphere, a bar, or a doughnut, whose specific surface area is increased as activated carbon is added to the EPP when the EPP is foamed. Preferably, the particle size of the floating media is reduced from 4˜6 mm to 2˜3 mm, thereby increasing the specific surface area of the floating media, so that the conventional tank can be used in existing systems without the need for a new tank.

As described above, the present invention improves the floating media and provides a system for treating recirculating nutrients using the floating media. The system can perform bio adsorption at the maximum efficiency using an improved floating media, in comparison to the conventional system where the conventional bio adsorption is not smoothly performed through the conventional floating microorganisms and floating media.

Since the system according to the present invention is configured to include the first and second anoxic tanks and the aerobic tank which are filled with a floating media and under whose bio membrane the partitions, shaped as a bar, a cross, a rectangle, and a diamond shape, are installed, it can smoothly perform the backwashing process and thus resolve the conventional backwashing problems where, since the conventional activated sludge process generates the sludge, it must further perform the sludge treatment. That is, in the conventional system, when the influent as an upstream flow flows continuously into the tanks with air injection for a certain period of time, the floating media is compressed and lumped. Therefore, the tightly hardened and lumped floating media moves without breaking, and thus the backwashing process of the conventional system cannot be performed smoothly.

### BRIEF DESCRIPTION OF THE DRAWINGS

The features and advantages of the present invention will be more apparent from the following detailed description in conjunction with the accompanying drawings, in which:

FIG. 1 is a cross-sectional view illustrating a first embodiment of a system for treating recirculating nutrients using floating media according to the present invention;

FIG. 2 is a cross-sectional view illustrating a second embodiment of a system for treating recirculating nutrients using floating media according to the present invention;

FIG. 3 is a cross-sectional view of a first embodiment of the present invention, illustrating a first anoxic tank, an aerobic tank, and a second anoxic tank;

FIG. 4 is a cross-sectional view of a second embodiment of the present invention, illustrating a first anoxic tank, an aerobic tank, and a second anoxic tank, in which the partition between the tanks has a solid stack structure;

FIG. 5 is a cross-sectional view of a second embodiment of the present invention, illustrating a first anoxic tank, an aerobic tank, and a second anoxic tank, in which the partition between the tanks has a planar structure;

FIG. 6 is a cross-sectional view of a third embodiment of the present invention, illustrating a first anoxic tank, an aerobic tank, and a second anoxic tank, in which the partition between the tanks has a solid stack structure;

FIG. 7 is a cross-sectional view of a third embodiment of the present invention, illustrating a first anoxic tank, an aerobic tank, and a second anoxic tank, in which the partition between the tanks has a planar structure;

FIG. 8 is a cross-sectional view of a fourth embodiment of the present invention, illustrating a first anoxic tank, an aerobic tank, and a second anoxic tank, in which the partition between the tanks has a solid stack structure;

FIG. 9 is a cross-sectional view of a fourth embodiment of the present invention, illustrating a first anoxic tank, an aerobic tank, and a second anoxic tank, in which the partition between the tanks has a planar structure; and

FIG. 10 is cross-sectional views illustrating floating-media partitions according to the present invention.

### BRIEF DESCRIPTION OF SYMBOLS IN THE DRAWINGS

1: first anoxic tank
2: second anoxic tank
3: aerobic tank A-floating media
5: partition

### DESCRIPTION OF THE PREFERRED EMBODIMENTS

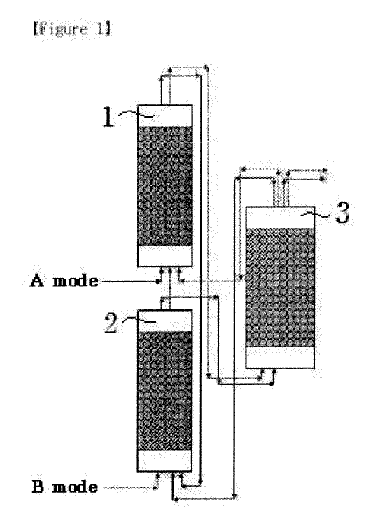

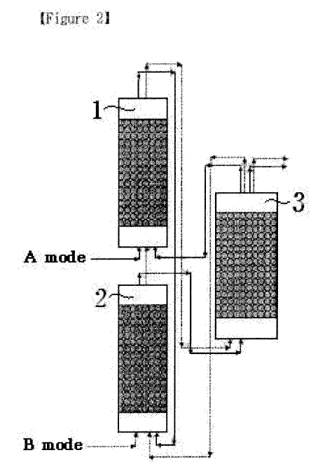

Hereinafter, exemplary embodiments of the present invention are described in detail with reference to the accompanying drawings. FIG. 1 is a cross-sectional view illustrating a first embodiment of a system for treating recirculating nutrients using floating media according to the present invention. FIG. 2 is a cross-sectional view illustrating a second embodiment of a system for treating recirculating nutrients using floating media according to the present invention.

As shown in FIG. 1, wastewater flows into tanks at mode A and mode B at a certain period of time interval. The wastewater flows into a first anoxic tank 1 at mode A and then flows into a second anoxic tank 2. The wastewater flows into the second anoxic tank 2 at mode B and then flows into the first anoxic tank 1.

First, the wastewater flows into the first anoxic tank 1 and the second anoxic tank 2.

In the first and second anoxic tanks 1 and 2, the wastewater undergoes an organic matter adsorption process, so that the treated water containing concentrated ammonium nitrogen flows into an aerobic tank 3.

The treated water that flows into the aerobic tank 3 undergoes a nitrification process through a floating media 4 that concentrates nitrifying bacteria within the aerobic tank 3. The nitrification-finished treated water is discharged in such a way that the treated water that flows at mode A flows into the second anoxic tank 2 and the treated water that flows at mode B flows into the first anoxic tank 1.

The first anoxic tank 1, second anoxic tank 2, and aerobic tank 3 each fill with the floating media 4 that serves a biological function by using attached-growth microorganisms to perform a filtering function as a physical function. It is preferable that the media is configured in such way that the cell structure is a closed form, and the material is made of EPs flexible due to PP resin. The media may be shaped as a sphere, a bar, or a doughnut.

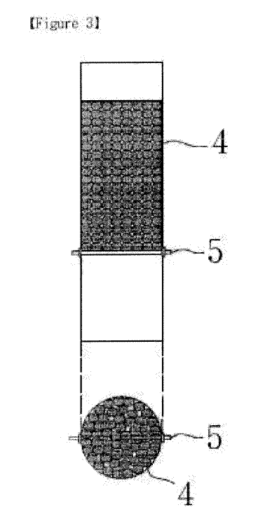

As shown in FIG. 3 to FIG. 9, the respective tanks 1, 2 and 3 filled with the floating media 4 include a partition 5 installed at the bottom thereof. The partition 5 is formed as a bar shape, a cross shape, a rectangle, or a trapezoidal shape. The partition 5 assists the floating media 4, which is solidified by compression of influent water for a certain period of time, to be separated therefrom, in comparison to the conventional art where the floating media 4 is firmly solidified. Therefore, the present invention can smoothly perform a backwashing process.

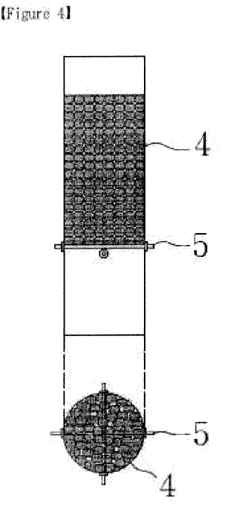

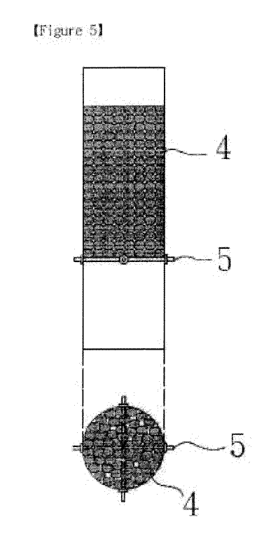

FIG. 4 and FIG. 5 show tanks to which a partition 5 of a cross shape structure is installed. The partition 5 may be implemented by a stack structure, as shown in FIG. 4, and by a planar structure, as shown in FIG. 5.

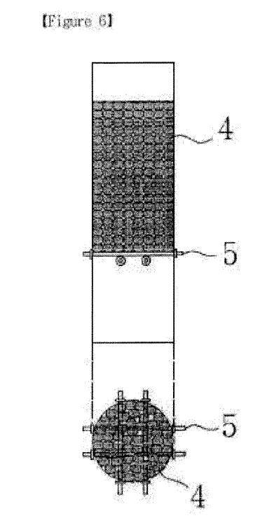

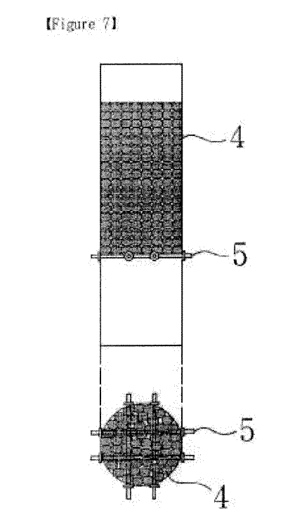

FIG. 6 and FIG. 7 show tanks to which a partition 5 of a rectangular shape structure is installed. The partition 5 may be implemented by a stack structure, as shown in FIG. 6, and by a planar structure, as shown in FIG. 7.

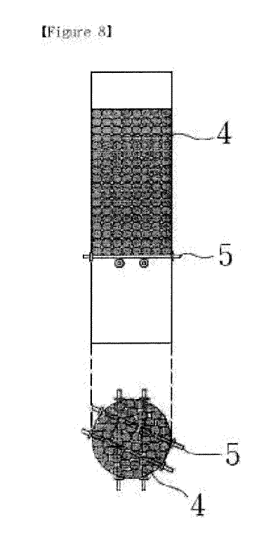

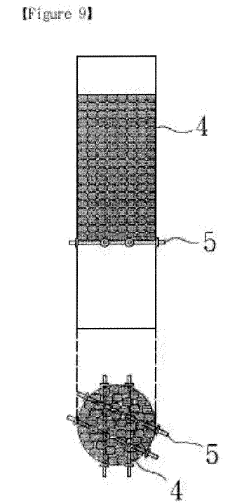

FIG. 8 and FIG. 9 show tanks to which a partition 5 of a trapezoidal shape structure is installed. The partition 5 may be implemented by a stack structure, as shown in FIG. 8, and by a planar structure, as shown in FIG. 9.

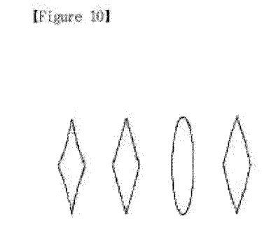

FIG. 10 is cross-sectional views illustrating floating-media partitions 5 according to the present invention. The partitions 5 are manufactured in such a way that their end portions cannot be acute to prevent the floating media from any damage and their top and bottom surface areas are designed to move smoothly when the floating media is moved up and down during the backwashing process. It is preferable that the partitions 5 are made of stainless or resistant-corrosion material.

The above described system according to the present invention will be explained in detail below, based on various processes.

Process 1

As shown in FIG. 1, the system for treating wastewater according to process 1 is configured to include a first anoxic tank 1, a second anoxic tank 2, and an aerobic tank 3. The respective tanks are filled with a floating media 4.

According to process 1, the wastewater flows into the first anoxic tank 1 from an inflow pump for a certain period of time at mode A, and then sequentially flows into the second anoxic tank 2 and the aerobic tank 3. After a certain period of time, for example, 30-60 mins, has elapsed, the path of the wastewater is changed from mode A to mode B, so that the wastewater can sequentially flow into the second anoxic tank 2, the first anoxic tank 1, and then the aerobic tank 3.

At mode A, the first anoxic tank 1 allows attached-growth microorganisms to adsorb organic matter contained in the wastewater. The organic matter adsorbed to the microorganism is nitrified by the concentrated nitrifying attached-growth bacteria through mode B, thus generating nitrate.

The nitrate is used for denitrification, thereby maximizing the use of organic matter.

After adsorption, the treated water containing the concentrated ammonium nitrogen passes through a strainer and flows into the aerobic tank 3. Part of the treated water that flows into the aerobic tank 3 may be recirculated continuously to the first anoxic tank 1 according to the conditions. Also, the treated water that flows into the first anoxic tank 1 through mode B is denitrified thereat and then flows out therefrom. Part of the effluent treated water is continuously recirculated to the first anoxic tank 1.

After the wastewater that flows into the first and second anoxic tanks 1 and 2 through mode A and mode B undergoes an organic adsorption process to thus turn into treated water containing concentrated ammonium nitrogen, the treated water flows into the aerobic tank 3. The ammonium nitrogen is nitrified by the nitrifying bacteria concentrated at the floating media 4 filling the aerobic tank 3.

The nitrification-finished treated water flows out of the strainer in such a way that the treated water, which flows through mode A, flows into the second anoxic tank 2, and the treated water, which flows through mode B, flows into the first anoxic tank 1. While the treated water is flowing, part of the treated water that flows into the first and second anoxic tanks 1 and 2 may be continuously recirculated, depending on the conditions.

The second anoxic tank 2 allows attached-growth microorganisms on the floating media 4 to adsorb organic matters contained in the wastewater that flows through mode B. The organic matter adsorbed to the microorganism flows into the aerobic tank 3 through mode A and is nitrified by the concentrated attached-growth nitrifying bacteria. After that the microorganism denitrifies the generated nitrate. Therefore, the present invention maximizes the use of organic matter. After the organic matter contained in the wastewater that flows through mode B is adsorbed, the treated water that flows into the aerobic tank 3 and the treated water that flows through mode A, undergoes the denitrifying process and passes through the strainer. Part of the treated water passing through the strainer is continuously recirculated in the first anoxic tank 1 to enhance the denitrification efficiency, according to the conditions.

Process 2

Process 2 is a process to enhance the denitrification efficiency of process 1.

As shown in FIG. 2, the nitrate, nitrified by the nitrifying microorganism attached to and growing on the floating media 4 of the aerobic tank 3, allows for internal recirculation at 1˜4 Q times the amount of inflow influent to the second anoxic tank 2 in the case of mode A, and at 1˜4 Q times the amount of inflow influent to the first anoxic tank 1 in the case of mode B, thereby maximizing the denitrification efficiency. Process 2 differs from process 1 in that the internal recirculation occurs from the aerobic tank 3, and the second anoxic tank 2, to the first anoxic tank 1. Process 2 and process 1 are similar to each other, with respect to inflow flowing, flowing path change time, and the function of respective tanks.

In process 1 and process 2 according to the present invention, the floating media 4, filling the first and second anoxic tanks 1 and 2 and the aerobic tank 3, undergoes a backwashing process once a day. The solid matter separated through the backwashing process is discharged through drain holes located at the bottom of the respective tanks.

The floating media 4 is made up of EPP whose cell structure is in a closed form and is flexible due to PP resin. The floating media 4 is shaped as a sphere, a bar, or a doughnut whose specific surface area is increased as activated carbon is added to the EPP when the EPP is foamed. When the particle size of the floating media has the particle size of 4˜6 mm to apply to a bio filtering system, it is preferable to select a material whose 2 density is 0.060-0.090 g/cm³. When the floating media has the particle size of 2-3 to apply to a bio filtering system, it is preferable to select a material whose density is 0.45-0.060 g/cm3 and whose absorption efficiency is 0.32 g/cm3. Since the particle size of the floating media size can be reduced from 4-6 mm to 2-3 mm, the present invention can use the conventional tank without installation of new tanks, therefore increasing the specific surface area.

The floating media is manufactured in such a way that: polypropylene resin of 96.0-98.5 wt %, activated carbon of 1-2.5 wt % as powder of 50˜250 μm, sands of 0.5-1.5 wt % or 50˜100 μm are mixed together and melted to produce resin beads! resin beads of 15.0-66.9 wt %, foam of 3-4 wt %, water of 30-80 wt %, and dispersant of 0.1-1 wt % are mixed together and stirred in a pressure-resistant container; the mixture is heated at a temperature of 147˜156° C., under 1.3-3.5 kgf/cm²; and the melted mixture is discharged into the air through a nozzle, thereby forming the floating media in the form of foam. This method enables the floating media to increase its specific surface area and density.

The configuration described above will now be explained in detail based on the following preferred embodiments of the present invention.

### Embodiment 1

### Operation of the System for Treating Recirculating Nutrients Using Floating Media

As shown in FIG. 1, the system for treating wastewater according to process 1 is configured to include a first anoxic tank 1, a second anoxic tank 2, and an aerobic tank 3. The respective tanks are filled with a floating media 4. According to process 1, the wastewater flows into the first anoxic tank 1 through an inflow pump for a certain period of time at mode A, and then sequentially flows into the second anoxic tank 2 and the aerobic tank 3. The system operates to change the inflow path every 45 minutes.

At mode A, the first anoxic tank 1 allows attached-growth microorganisms to adsorb organic matters contained in the wastewater. The organic matter adsorbed by the microorganism is nitrified by the concentrated nitrifying attached-growth bacteria through mode B, thus generating nitrate. The nitrate is used for denitrification, thereby maximizing the use of organic matter.

After the adsorption, the treated water containing the concentrated ammonium nitrogen passes through a strainer and flows into the aerobic tank 3. Part of treated water that flows into the aerobic tank 3 may be continuously recirculated to the first anoxic tank 1 according to the conditions. Also, after 45 minutes, the treated water that flows into the first anoxic tank 1 through mode B is denitrified thereat and then flows out therefrom. Part of effluent treated water is continuously recirculated to the first anoxic tank 1.

### Embodiment 2

### Backwashing Method of the System for Treating Recirculating Nutrients Using Floating Media

As shown in FIGS. 1 and 2, the system for treating wastewater according to processes 1 and 2 is configured to include a first anoxic tank 1, a second anoxic tank 2, and an aerobic tank 3. The respective tanks are filled with a floating media 4. When the system operates for a relatively long period of time, it should carry out the backwashing process. To perform the backwashing process smoothly, as shown in FIG. 3 to FIG. 9, the partitions are installed horizontally under the floating media or installed alternatively as a stack structure. Therefore, the present invention can resolve the conventional problems involved in the backwashing process.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Therefore I claim:

1. A system for treating recirculating nutrients using floating media, wherein wastewater influent path is changed between a first mode and a second mode at a certain period of time interval, wherein the system comprises:
a. the first mode where wastewater sequentially flows into a first anoxic tank and a second anoxic tank in which microorganism adsorbs organic matter contained in the wastewater, and then an aerobic tank in which the wastewater concentrating ammonia nitrogen, which has undergone the organic matter adsorption process, is nitrified by concentrated nitrifying bacteria, at a certain period of time interval; and
b. a second mode where wastewater sequentially flows into the second anoxic tank and the first anoxic tank in which microorganism adsorb organic matter contained in the wastewater, and then an aerobic tank in which the wastewater concentrating ammonia nitrogen, which has undergone the organic matter adsorption process, is nitrified by concentrated nitrifying bacteria; and part of the wastewater that flows into the aerobic tank at the first mode and the second mode bypasses the first anoxic tank or the second anoxic tank; or part of the wastewater that flows from the aerobic tank into the first anoxic tank or from the aerobic tank into the second anoxic tank continuously bypasses the aerobic tank through an internal recirculation pump.

2. The system for treating recirculating nutrients using floating media according to claim 1, wherein:
a. the first mode allows for internal recirculation at 1˜4 Q times the amount of influent from the aerobic tank to the second anoxic tank to enhance the denitrification efficiency; and
b. the second mode allows for internal recirculation at 1˜4 Q times the amount of influent from the aerobic tank (3) to the first anoxic tank (1) to enhance the denitrification efficiency.

3. The system for treating recirculating nutrients using floating media according to claim 1, wherein the first and second anoxic tanks and the aerobic tank are filled with a floating media.

4. The system for treating recirculating nutrients using floating media according to claim 3, wherein:
a. the floating media comprises EPP whose cell structure is a closed form and is flexible due to PP resin; and the floating media is shaped as a sphere, a bar, or a doughnut, whose specific surface area is increased as activated carbon is added to the EPP when the EPP is foamed.

5. The system for treating recirculating nutrients using floating media according to claim 3, wherein the floating media is manufactured in such a way that:
a. polypropylene resin of 96.0-98.5 wt %, activated carbon of 1-2.5 wt % shaped as powder of 50-250 μm, sands of 0.5-1.5 wt % or 50-100 μm are mixed together and melted to produce resin beads;
b. resin beads of 15.0-66.9 wt %, foam of 3-4 wt %, water of 30-80 wt %, and dispersant of 0.1-1 wt % are mixed together and stirred in a pressure-resistant container; the mixture is heated at a temperature of 147-156° C., under 1.3-3.5 kgf/cm²; and the melted mixture is discharged into the air through a nozzle and is foamed, wherein the particle size of the floating media is reduced from 4-6 mm to 2-3 mm, thereby increasing the specific surface area of the floating media, so that the conventional tank can be used in existing systems without the need for a new tank.

6. The system for treating recirculating nutrients using floating media according to claim 1, wherein
a. the first and second anoxic tanks and the aerobic tank install partitions, shaped as a bar, a cross, a rectangle, or a diamond shape, thereunder horizontally or orthogonally alternatively,
b. the partitions are operatively configured to easily break the floating media lump during the backwashing process, thereby enhancing the backwashing efficiency.

7. A system for treating recirculating nutrients using floating media, wherein a wastewater influent path is changed between a first mode and a second mode at a certain time interval, the system comprising:
i. a first anoxic tank;
ii. a second anoxic tank;
iii. a n aerobic tank;
iv.
v. the first mode where wastewater sequentially flows into the first anoxic tank and the second anoxic tank in which microorganism adsorbs organic matter contained in the wastewater, and operatively configured that the wastewater flows into the aerobic tank in which the wastewater interacts with concentrating ammonia nitrogen, which has undergone the organic matter adsorption process, the wastewater is nitrified by the nitrifying bacteria, at a certain period of time interval; and
vi. the second mode operatively configured such that wastewater sequentially flows into the second anoxic tank and the first anoxic tank in which microorganism adsorb organic matter contained in the wastewater, and then into the aerobic tank in which the wastewater interacts with ammonia nitrogen, which has undergone the organic matter adsorption process, is nitrified by concentrated nitrifying bacteria; and part of the wastewater that flows into the aerobic tank at the first mode and the second mode bypasses the first anoxic tank or the second anoxic tank; or part of the wastewater that flows from the aerobic tank into the first anoxic tank or from the aerobic tank into the second anoxic tank continuously bypasses the aerobic tank through an internal recirculation pump.

8. A method for treating recirculating nutrients using floating media, wherein a wastewater influent path is changed between a first mode and a second mode at a certain time interval, the method comprising the steps of:
a. the first mode where wastewater sequentially flows into the first anoxic tank and the second anoxic tank in which microorganism adsorbs organic matter contained in the wastewater, and then into the aerobic tank in which the wastewater concentrating ammonia nitrogen, which has undergone the organic matter adsorption process, is nitrified by the nitrifying bacteria, at a certain period of time interval; and
b. the second mode where wastewater sequentially flows into the second anoxic tank and the first anoxic tank in which microorganism adsorb organic matter contained in the wastewater, and then into the aerobic tank in which the wastewater interacts with ammonia nitrogen, which has undergone the organic matter adsorption process, is nitrified by concentrated nitrifying bacteria; and part of the wastewater that flows into the aerobic tank at the first mode and the second mode bypasses the first anoxic tank or the second anoxic tank; or part of the wastewater that flows from the aerobic tank into the first anoxic tank or from the aerobic tank into the second anoxic tank continuously bypasses the aerobic tank through an internal recirculation pump.
